(19) United States
(12) Patent Application Publication
(10) Pub. No.: US 2023/0193845 A1
(43) Pub. Date: Jun. 22, 2023

(54) Internal Combustion Engine Control Device

(71) Applicant: Hitachi Astemo, Ltd., Hitachinaka-shi, Ibaraki (JP)

(72) Inventors: Ryutaro KOIWAI, Tokyo (JP); Yoichi IIHOSHI, Tokyo (JP); Kohei SUZUKI, Hitachinaka-shi (JP)

(21) Appl. No.: 17/925,636

(22) PCT Filed: Feb. 5, 2021
(86) PCT No.: PCT/JP2021/004271

§ 371 Date: Nov. 16, 2022

(30) Foreign Application Priority Data
Jun. 15, 2020 (JP) 2020-103324

(51) Int. Cl. F02D 41/26; F02D 41/00

(52) U.S. Cl. CPC F02D 41/26; F02D 41/0002; F02D 2200/0406; F02D 2200/0404; F02D 2200/0414

(57) ABSTRACT

An internal combustion engine control device 110 includes a mass flux calculation unit F2, an opening area calculation unit F3, an effective opening area calculation unit F4, and a passing gas flow rate calculation unit F5. The mass flux calculation unit F2 calculates a mass flux MF of gas passing through a throttle valve 125 based on an upstream gas temperature Tu, an upstream gas pressure Pu, and a downstream gas pressure Pd of the throttle valve 125. The opening area calculation unit F3 calculates an opening area A of the throttle valve 125 based on an opening degree θ of the throttle valve 125. The effective opening area calculation unit F4 calculates an effective opening area EA of the throttle valve 125 based on the upstream gas pressure Pu, the downstream gas pressure Pd, the opening degree θ, and the opening area A. The passing gas flow rate calculation unit F5 calculates a gas flow rate GF passing through the throttle valve 125 based on the mass flux MF and the effective opening area EA.

### TECHNICAL FIELD

The present disclosure relates to an internal combustion engine control device.

### BACKGROUND ART

Conventionally, an invention related to an internal combustion engine control device in which a method of calculating an in-cylinder filling air amount of the internal combustion engine is improved has been known (the following PTL 1). The internal combustion engine control device described in PTL 1 controls an internal combustion engine including an electronic throttle system that controls a throttle opening degree by driving a throttle valve with a throttle actuator. A conventional the internal combustion engine control device includes an opening degree command value calculation unit, a delay unit, a throttle opening degree prediction unit, an in-cylinder filling air amount prediction unit, and a fuel injection amount calculation unit (claim 1 of PTL 1).

The opening degree command value calculation unit calculates an opening degree command value based on an accelerator operation amount or the like. The delay unit delays a timing when the opening degree command value calculated by the opening degree command value calculation unit is output to the throttle actuator. The throttle opening degree prediction unit predicts the subsequent throttle opening degree before the delayed output of the opening degree command value based on the opening degree command value before being delayed by the delay unit and response delay characteristics of the electronic throttle system. The in-cylinder filling air amount prediction unit predicts an in-cylinder filling air amount based on the throttle opening degree predicted by the throttle opening degree prediction unit. The fuel injection amount calculation unit calculates a fuel injection amount based on the in-cylinder filling air amount predicted by the in-cylinder filling air amount prediction unit.

The in-cylinder filling air amount prediction unit predicts a change amount of the in-cylinder filling air amount until an intake valve closing timing based on the throttle opening degree predicted by the throttle opening degree prediction unit.

Then, the in-cylinder filling air amount prediction unit adds the predicted change amount to the base in-cylinder filling air amount calculated based on a current operation parameter to predict the in-cylinder filling air amount (claim 2 of PTL 1).

The in-cylinder filling air amount prediction unit regards a throttle opening degree through which the intake air passes as an orifice, and uses an intake system model in which the mass preservation law is applied to the amount of air passing through the throttle and the intake air flowing through the throttle downstream passage. Then, the in-cylinder filling air amount prediction unit predicts the change amount in the in-cylinder filling air amount until the intake valve closing timing by integrating the change amount in the output of the intake system model until the intake valve closing timing (claim 3 of PTL 1).

A formula for calculating a throttle passing air amount in the intake system model is set as follows.

$$\begin{matrix}[ Equation 1 ] & \\ {G}_{in} = μ \cdot A \cdot \frac{P a}{\sqrt{R \cdot T}} \cdot f ( Pm / P a ) & \end{matrix}$$

$$A = π {r}^{2} ( 1 - {cos}^{2} θ )$$

In the above formula, Gᵢₙ represents the throttle passing air amount [kg/sec]. μ is a flow rate coefficient, and A is a throttle opening effective cross-sectional area [m²]. Pa is an atmospheric pressure [Pa], Pm is an intake air pressure [Pa], R is a gas constant, and T is an intake air temperature [K]. (Pm/Pa) is a physical value determined by a ratio between the intake air pressure Pm and the atmospheric pressure Pa. r is a radius [m] of a throttle valve, and θ is a throttle opening degree. The in-cylinder filling air amount prediction unit calculates the throttle passing air amount. At that time, the in-cylinder filling air amount prediction unit calculates f(Pm/Pa) from a table having Pm/Pa as a parameter, and calculates μ·A from a table having the throttle opening degree as a parameter (claim 4 of PTL 1).

### CITATION LIST

### Patent Literature

PTL 1: JP 2002-201998 A

### SUMMARY OF INVENTION

### Technical Problem

In the conventional internal combustion engine control device, for example, when a pressure of air on an upstream side and a downstream side of the throttle valve rapidly changes at the time of transient operation of the internal combustion engine, μ·A calculated from the table may not match an actual μ·A. In this case, an error occurs in the calculation result of the throttle passing air amount, and as a result, the prediction accuracy of the in-cylinder filling air amount decreases.

The present disclosure provides an internal combustion engine control device capable of estimating an in-cylinder inflow gas amount of the internal combustion engine with higher accuracy than before.

### Solution to Problem

According to an aspect of the present disclosure, there is provided an internal combustion engine control device including: a mass flux calculation unit that calculates a mass flux of gas passing through a throttle valve based on an upstream gas temperature, an upstream gas pressure, and a downstream gas pressure of the throttle valve; an opening area calculation unit that calculates an opening area of the throttle valve based on an opening degree of the throttle valve; an effective opening area calculation unit that calculates an effective opening area of the throttle valve based on the upstream gas pressure, the downstream gas pressure, the opening degree, and the opening area; and a passing gas flow rate calculation unit that calculates a gas flow rate passing through the throttle valve based on the mass flux and the effective opening area.

### Advantageous Effects of Invention

According to the above aspect of the present disclosure, it is possible to provide an internal combustion engine control device capable of estimating an in-cylinder inflow gas amount of an internal combustion engine with higher accuracy than before.

### BRIEF DESCRIPTION OF DRAWINGS

FIG. 1 is a system configuration diagram illustrating one embodiment of an internal combustion engine control device according to the present disclosure.

FIG. 2 is a block diagram illustrating a schematic configuration of the internal combustion engine control device of FIG. 1.

FIG. 3 is a functional block diagram of the internal combustion engine control device of FIG. 2.

FIG. 4 is a flowchart illustrating an example of a flow of processing by the internal combustion engine control device of FIG. 3.

FIG. 5 is a more detailed functional block diagram of an effective opening area calculation unit illustrated in FIG. 3.

FIG. 6 is a graph illustrating a relationship between a differential pressure ΔP of a throttle valve and a correction coefficient μ.

FIG. 7 is a graph illustrating a relationship between an opening degree θ of a throttle valve and the correction coefficient ρ.

FIG. 8 is a schematic diagram of a flow of gas passing through a throttle valve.

FIG. 9 is a graph for explaining an action by the internal combustion engine control device of FIG. 3.

FIG. 10 is a flowchart illustrating an example of a flow of processing by the internal combustion engine control device of FIG. 3.

FIG. 11 is a graph for explaining an action by processing of the internal combustion engine control device illustrated in FIG. 10.

### DESCRIPTION OF EMBODIMENTS

Hereinafter, some embodiments of an internal combustion engine control device according to the present disclosure will be described with reference to the drawings.

### First Embodiment

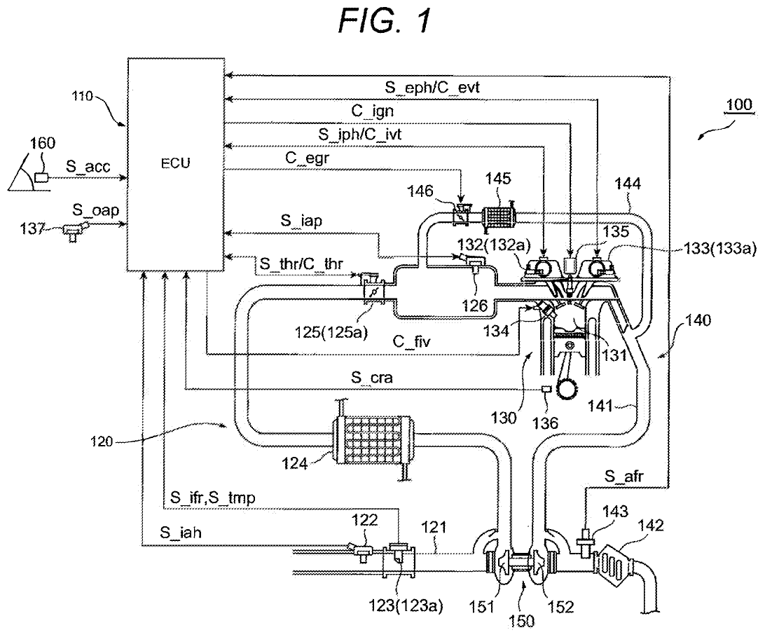

FIG. 1 is a system configuration diagram illustrating one embodiment of the internal combustion engine control device according to the present disclosure.

An internal combustion engine control device 110 according to the present embodiment is, for example, an engine control unit (ECU) that controls an engine system 100 illustrated in FIG. 1. The engine system 100 includes, for example, a control device 110, an intake system 120, an engine 130, an exhaust system 140, and a supercharger 150.

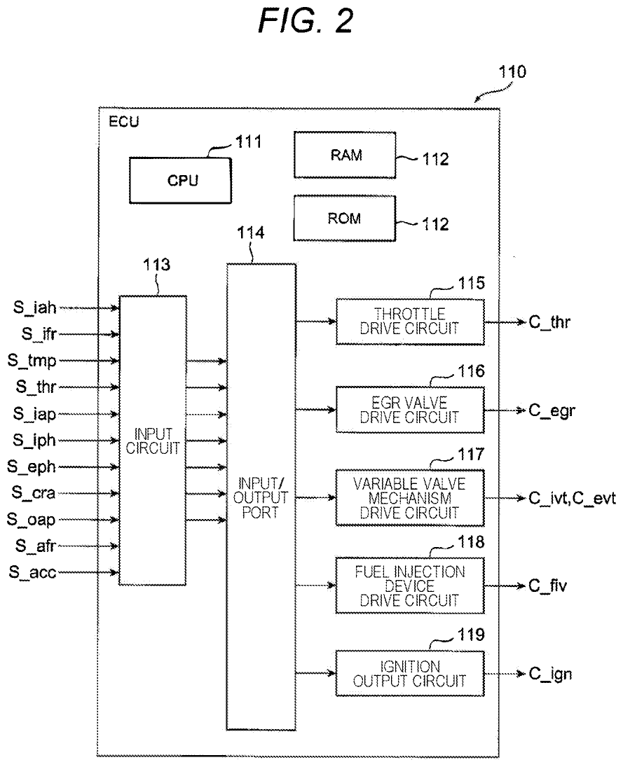

FIG. 2 is a block diagram illustrating a schematic configuration of the internal combustion engine control device 110 constituting the engine system 100 of FIG. 1. The internal combustion engine control device 110 of the present embodiment includes, for example, a processing device 111 including a CPU, a storage device 112 including a RAM, a ROM, and the like, and a plurality of computer programs and data stored in the storage device 112. Furthermore, the control device 110 includes, for example, an input circuit 113 and an input/output port 114.

The control device 110 includes various circuits such as a throttle drive circuit 115, an EGR, valve drive circuit 116, a variable valve mechanism drive circuit 117, a fuel injection device drive circuit 118, and an ignition output circuit 119. Note that the control device 110 may not include these drive circuits, and at least some of these drive circuits may be provided outside the control device 110.

The intake system 120 includes, for example, an intake pipe 121, an atmospheric humidity sensor 122, a mass flowmeter 123, an intercooler 124, a throttle valve 125, and an intake pipe pressure sensor 126. The intake pipe 121 takes in outside air from the outside of the engine system 100 and supplies the outside air to the engine 130. The atmospheric humidity sensor 122 is provided in the intake pipe 121 and measures a humidity of the air sucked into the intake pipe 121. The mass flowmeter 123 is provided at the inlet of the intake pipe 121 and measures a mass flow rate of the air sucked into the intake pipe 121. The mass flowmeter 123 incorporates, for example, an intake air temperature sensor 123a that measures an intake air temperature.

The supercharger 150 includes a compressor 151 that compresses sucked air and a turbine 152 that drives the compressor 151 using exhaust energy. The intercooler 124 is provided on the downstream side of the supercharger 150 in the flow of air in the intake pipe 121, and cools the air compressed by the compressor 151 of the supercharger 150. The throttle valve 125 adjusts an intake air amount taken into the engine 130. The throttle valve 125 incorporates, for example, a throttle position sensor 125a that measures the opening degree θ of the throttle valve 125. The intake pipe pressure sensor 126 is provided on the downstream side of the throttle valve 125 in the flow of air in the intake pipe 121, and measures the pressure of the air flowing through the intake pipe 121.

The engine 130 is, for example, a spark ignition type internal combustion engine. The engine 130 includes, for example, a combustion chamber 131, a variable intake valve mechanism 132, a variable exhaust valve mechanism 133, a fuel injection device 134, an ignition plug 135, a crank angle sensor 136, and an atmospheric pressure sensor 137. The variable intake valve mechanism 132 includes a phase sensor 132a that detects an open/close phase of the intake valve, and controls the open/close phase of the intake valve. The variable exhaust valve mechanism 133 includes a phase sensor 133a that detects an open/close phase of the exhaust valve, and controls the open/close phase of the exhaust valve. The fuel injection device 134 injects fuel into the combustion chamber 131. The ignition plug 135 supplies ignition energy to an air-fuel mixture in the combustion chamber 131. The crank angle sensor 136 measures a crank angle, and the atmospheric pressure sensor 137 measures the atmospheric pressure.

The exhaust system 140 includes, for example, an exhaust pipe 141, a catalytic converter 142, an air-fuel ratio sensor 143, an EGR pipe 144, an EGR cooler 145, and an EGR valve 146. The exhaust pipe 141 discharges exhaust gas from the engine 130 to the outside. The catalytic converter 142 is provided in the exhaust pipe 141 and purifies the exhaust gas flowing through the exhaust pipe 141. The air-fuel ratio sensor 143 is provided on the upstream side of the catalytic converter 142 in the exhaust pipe 141 in the exhaust flow, and measures the air-fuel ratio of the exhaust. The air-fuel ratio sensor 143 may be replaced with, for example, an oxygen concentration sensor.

The EGR pipe 144 is a pipe for performing exhaust gas recirculation (EGR), and is branched from the upstream side of the flow of exhaust gas of the turbine 152 of the supercharger 150 in the exhaust pipe 141, and is connected to the intake pipe 121 on the downstream side of the flow of air taken in from the throttle valve 125, for example. The EGR cooler 145 cools exhaust gas flowing through the EGR pipe 144 and circulating to the intake pipe 121. The EGR valve 146 adjusts the flow rate of the exhaust gas flowing through the EGR pipe 144 and circulating to the intake pipe 121.

The internal combustion engine control device 110 according to the present embodiment is connected to various sensors and actuators provided in the intake system 120, the engine 130, and the exhaust system 140 so as to be capable of communicating information via a wireless or wired communication line or signal wiring, for example. Further, the control device 110 is similarly connected to an accelerator opening degree sensor 160 that measures an opening degree of an accelerator pedal of a vehicle on which the engine system 100 is mounted in an information-communicable manner.

More specifically, the control device 110 is connected to, for example, the atmospheric humidity sensor 122, the mass flowmeter 123, the intake air temperature sensor 123a, the throttle valve 125, the throttle position sensor 125a, and the intake pipe pressure sensor 126 in an information-communicable manner. The atmospheric humidity sensor 122, the mass flowmeter 123, the intake air temperature sensor 123a, the throttle position sensor 125a, and the intake pipe pressure sensor 126 output signals S_iah, S_ifr, S_tmp, S_thr, and S_iap according to the measurement values, respectively. The signals S_iah, S_ifr, S_tmp, S_thr, and S_iap output from the sensors of the intake system 120 are input to, for example, the input circuit 113 of the control device 110.

In addition, the control device 110 is connected to, for example, the variable intake valve mechanism 132, the variable exhaust valve mechanism 133, the phase sensors 132a and 133a, the fuel injection device 134, the ignition plug 135, the crank angle sensor 136, and the atmospheric pressure sensor 137 in an information-communicable manner. The phase sensor 132a of the variable intake valve mechanism 132, the phase sensor 133a of the variable exhaust valve mechanism 133, the crank angle sensor 136, and the atmospheric pressure sensor 137 output signals S_iph, S_eph, S_cra, and S_oap according to the measurement values, respectively. The signals S_iph, S_eph, S_cra, and S cap output from the sensors of the engine 130 are input to the input circuit 113 of the control device 110, for example.

Furthermore, the control device 110 is connected to, for example, the air-fuel ratio sensor 143 and the EGR valve 146 in an information-communicable manner. The air-fuel ratio sensor 143 of the exhaust system 140 outputs a signal S_afr corresponding to the measurement value. The signal S_afr output from the air-fuel ratio sensor 143 is input to, for example, the input circuit 113 of the control device 110. Further, the control device 110 is connected to, for example, the accelerator opening degree sensor 160 in an information-communicable manner.

The accelerator opening degree sensor 160 outputs a signal S_acc corresponding to the measurement value. The signal S_acc output from the accelerator opening degree sensor 160 is input to the input circuit 113 of the control device 110, for example. Note that the signals input to the control device 110 are not limited to the signals illustrated in FIG. 2.

The input circuit 113 of the control device 110 transmits the input signal to the input/output port 114. The input circuit 113 includes, for example, an A/D converter, and when an analog signal is included in the input signal, the analog signal is converted into a digital signal by the A/D converter and the digital signal is sent to the input/output port 114. A numerical value of the input signal sent from the input circuit 113 to the input/output port 114 is held in the RAM constituting the storage device 112 and used for arithmetic processing by the processing device 111. The computer program that defines the content of the arithmetic processing by the processing device 111 is recorded in, for example, the ROM constituting the storage device 112.

The processing device 111 calculates a required torque of the engine 130 based on, for example, a signal S_acc corresponding to a measurement value of an accelerator opening output from the accelerator opening degree sensor 160 and signals output from the other sensors. That is, the accelerator opening degree sensor 160 can be used as a required torque detection sensor for detecting the required torque of the engine 130. In addition, the processing device 111 calculates a control amount of each unit of the engine system 100 based on an operation state of the engine 130 estimated from outputs of various sensors provided in each unit of the engine system 100.

Specifically, the processing device 111 calculates the control amount of each unit of the engine system 100 as follows, for example, based on the operation state of the engine 130. The processing device 111 calculates, for example, the opening degree θ of the throttle valve 125, an injection pulse period of the fuel injection device 134, an ignition timing of the ignition plug 135, opening/closing timings of the variable intake valve mechanism 132 and the variable exhaust valve mechanism 133, an opening degree of the EGR valve 146, and the like.

For example, the processing device 111 records the calculated control amount of each unit in the RAM constituting the storage device 112. In addition, for example, the processing device 111 outputs the control amount of each unit to the throttle drive circuit 115, the EGR valve drive circuit 116, the variable valve mechanism drive circuit 117, the fuel injection device drive circuit 118, and the ignition output circuit 119 via the input/output port 114.

For example, the throttle drive circuit 115 converts the opening degree θ of the throttle valve 125 input via the input/output port 114 into a control signal C_thr of the throttle valve 125 and outputs the control signal C_thr to the throttle valve 125. For example, the EGR. valve drive circuit 116 converts the opening degree of the EGR valve 146 input via the input/output port 114 into a control signal C_egr of the EGR valve 146 and outputs the control signal C_egr to the EGR valve 146.

The variable valve mechanism drive circuit 117 receives, for example, opening/closing timings of the variable intake valve mechanism 132 and the variable intake valve mechanism 132 via the input/output port 114. The variable valve mechanism drive circuit 117 converts the input opening/closing timing into control signals C_ivt and C_evt of the variable intake valve mechanism 132 and the variable intake valve mechanism 132, and outputs the control signals to the variable intake valve mechanism 132 and the variable exhaust valve mechanism 133.

For example, the fuel injection device drive circuit 118 converts the injection pulse period of the fuel injection device 134 input via the input/output port 114 into a control signal C_fiv of the fuel injection device 134 and outputs the control signal to the fuel injection device 134. The ignition output circuit 119 converts the ignition timing of the ignition plug 135 input via the input/output port 114 into a control signal C_ign of the ignition plug 135, and outputs the control signal C_ign to the ignition plug 135.

The engine system 100 injects the fuel from the fuel injection device 134 into the air taken into the intake pipe 121 and flowing into the combustion chamber 131 through the throttle valve 125 and the variable intake valve mechanism 132 to generate an air-fuel mixture in the combustion chamber 131. Then, the air-fuel mixture is combusted by ignition of the ignition plug 135, and the piston is pushed down by the combustion pressure, thereby generating a driving force in the engine 130.

The exhaust gas after combustion of the air-fuel mixture in the combustion chamber 131 of the engine 130 passes through the variable exhaust valve mechanism 133, the exhaust pipe 141, and the turbine 152, and is discharged to the outside of the engine system 100 after components such as NOx, CO, and HC are purified by the catalytic converter 142. A part of the exhaust gas is recirculated to the intake pipe 121 via the EGR pipe 144, the EGR cooler 145, and the EGR valve 146.

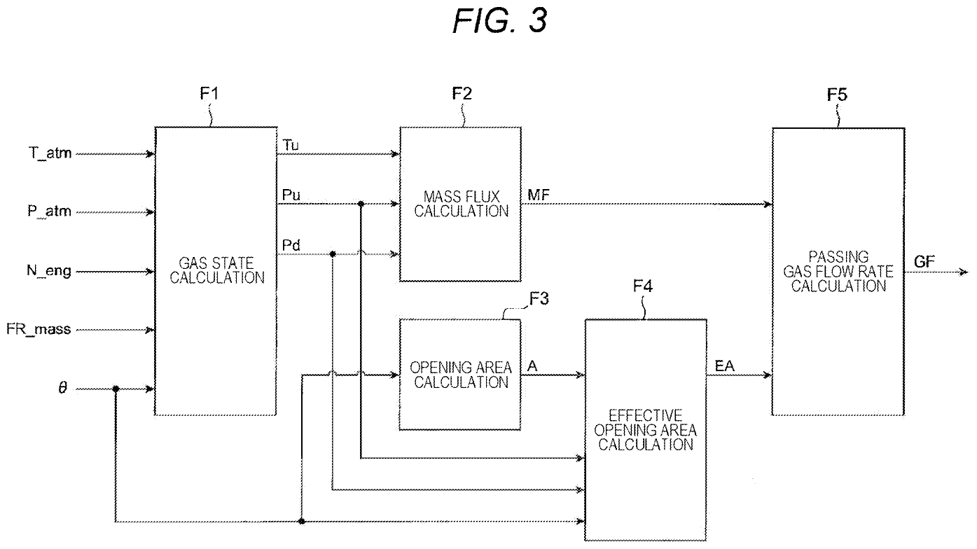

FIG. 3 is a functional block diagram of the internal combustion engine control device 110 of the present embodiment illustrated in FIG. 2.

The control device 110 includes, for example, a gas state calculation unit F1, a mass flux calculation unit F2, an opening area calculation unit F3, an effective opening area calculation unit F4, and a passing gas flow rate calculation unit F5.

Each unit of the control device 110 represents, for example, a function of the control device 110 realized by executing a computer program stored in the storage device 112 by the processing device 111.

That is, the gas state calculation unit F1, the mass flux calculation unit F2, the opening area calculation unit F3, the effective opening area calculation unit F4, and the passing gas flow rate calculation unit F5 can be rephrased as a gas state calculation function, a mass flux calculation function, an opening area calculation function, an effective opening area calculation function, and a passing gas flow rate calculation function, respectively.

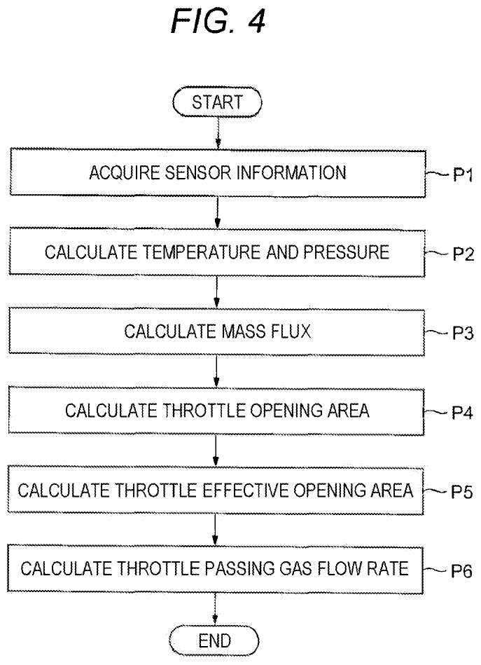

Hereinafter, an example of an operation of the internal combustion engine control device 110 according to the present embodiment will be described with reference to FIGS. 4 to 9.

FIG. 4 is a flowchart illustrating an example of a flow of processing of calculating a gas flow rate passing through the throttle valve 125 by the internal combustion engine control device 110 according to the present embodiment.

When starting the processing illustrated in FIG. 4, the control device 110 first executes processing P1 for acquiring sensor information.

In the processing P1, the control device 110 acquires, for example, an intake air temperature T_atm based on the output signal S_tmp of the intake air temperature sensor 123a and an atmospheric pressure P_atm based on the output S_oap of the atmospheric pressure sensor 137. In the processing P1, the control device 110 acquires, for example, a rotation speed N_eng of the engine 130 based on the output signal S_cra of the crank angle sensor 136 and a mass flow rate FR_mass of the intake air based on the output signal S_ifr of the mass flowmeter 123.

Further, in the processing P1, the control device 110 acquires the opening degree θ of the throttle valve 125 based on the output signal S_thr of the throttle position sensor 125a. In the processing P1, for example, the control device 110 executes a program recorded in the storage device 112 by the processing device 111, and processes an output signal of each sensor input to the input circuit 113 and stored in the storage device 112, so that the measurement result of each sensor can be acquired.

Next, the control device 110 executes processing P2 of calculating the temperature and the pressure of the gas in the intake system 120. For example, the control device 110 calculates the temperature and the pressure of the gas in the intake system 120 by the gas state calculation unit F1 illustrated in FIG. 3. The gas state calculation unit F1 receives, for example, the intake air temperature T_atm, the atmospheric pressure P_atm, the rotation speed N_eng of the engine 130, the mass flow rate FR_mass of the intake air, and the opening degree θ of the throttle valve 125 acquired in the previous processing P1.

The gas state calculation unit F1 calculates, for example, the upstream gas temperature Tu and the upstream gas pressure Pu, which are the temperature and the pressure of the gas on the upstream side of the throttle valve 125, and the downstream gas pressure Pd, which is the pressure of the gas on the downstream side of the throttle valve 125, based on the above input.

In the present embodiment, the upstream side of the throttle valve 125 is, for example, a portion from the outlet of the intercooler 124 to the inlet of the throttle valve 125 in the intake pipe 121. The downstream side of the throttle valve 125 is, for example, a portion from the outlet of the throttle valve 125 to the inlet of the combustion chamber 131 in the intake pipe 121.

Here, in the control device 110 of the present embodiment, for example, the basic principle of the intake system physical model used for estimating the air behavior from the change in the opening degree θ of the throttle valve 125 until the change in the amount of the in-cylinder inflow gas flowing into the combustion chamber 131 of the engine 130 occurs will be described. Here, a path from the intake port of the intake pipe 121 to the combustion chamber 131 of the engine 130 is divided into three control volumes (CV).

The first CV is, for example, a CV on the upstream side of the throttle from the intake port of the intake pipe 121 to the inlet of the throttle valve 125. The second CV is, for example, a CV on the downstream side of the throttle valve 125 from the outlet of the throttle valve 125 to the inlet of the combustion chamber 131 of the engine 130. The third CV is, for example, a CV of the combustion chamber 131 or cylinder of the engine 130.

Further, sensor detection values including the intake air temperature T_atm, the atmospheric pressure P_atm, the mass flow rate FR_mass of the intake air, and the opening degree θ of the throttle valve 125 acquired in the previous processing P1 are used. Then, the upstream gas temperature Tu and the upstream gas pressure Pu of the throttle valve 125 and the downstream gas pressure Pd of the throttle valve 125 are calculated based on the following basic formulas (1) to (4).

$$\begin{matrix}[ Equation 2 ] & \\ \frac{d m}{dt} = \frac{d {m}_{i n}}{dt} + \frac{d {m}_{out}}{dt} & ( 1 )\end{matrix}$$

$$\frac{d m \cdot e}{dt} = \frac{\text{?}}{\text{?} - 1} {T}_{i n} \cdot \frac{d {m}_{i n}}{dt} - \frac{\text{?}}{\text{?} - 1} {T}_{out} \cdot \frac{d {m}_{out}}{dt} - \frac{dQ}{dt} \qquad ( 2 )$$

$$P = \frac{m}{V} RT \qquad ( 3 )$$

$$T = \frac{\text{?} \cdot 1}{R} e \qquad ( 4 )$$

$$\text{?} \text{indicates text missing or illegible when filed}$$

In the above formulas (1) to (4), m is a mass, e is energy, T is a temperature, κ is a specific heat ratio, R is a gas constant, Q is a heat quantity, and V is a volume. In addition, subscripts in and out attached to the mass m, the specific heat ratio κ, and the gas constant R represent inflow and outflow to the CV, respectively. That is, for example, the gas state calculation unit F1 calculates the change amount in the mass of the gas and the change amount in the energy at the current time using the gas flow rate and the temperature calculated at the time of calculation one cycle before for each CV. Next, the gas state calculation unit F1 calculates the temperature and the pressure of each CV from the calculated change amount of the mass of the gas and the calculated change amount of the energy.

Next, the control device 110 executes processing P3 for calculating the mass flux of the gas passing through the throttle valve 125. For example, the control device 110 calculates the mass flux MF of the gas passing through the throttle valve 125 by the mass flux calculation unit F2 illustrated in FIG. 3. The mass flux calculation unit F2 receives, for example, the upstream gas temperature Tu and the upstream gas pressure Pu of the throttle valve 125 and the downstream gas pressure Pd of the throttle valve 125 calculated in the previous processing P2.

Based on the above input, the mass flux calculation unit F2 calculates, for example, a mass flow rate per unit area passing through the throttle valve 125, that is, a mass flux HF. Here, for example, the mass flux calculation unit F2 regards the throttle valve 125 as an orifice, constructs a hydrodynamic model around the throttle, and calculates the mass flux of the gas passing through the throttle valve 125. The mass flux calculation unit F2 calculates the mass flux MF based on, for example, the upstream gas temperature Tu of the throttle valve 125, the upstream gas pressure Pu and the downstream gas pressure Pd before and after the throttle valve 125, and the following formulas (5) to (7) stored in the storage device 112.

$$\begin{matrix}[ Equation 3 ] & \\ MF = Pu \cdot \sqrt{\frac{2}{R \cdot \text{?}}} \cdot \text{?} ( Pu , Pd ) & ( 5 )\end{matrix}$$

$$\text{?} \qquad ( 6 )$$

$$\text{?} \qquad ( 7 )$$

$$\frac{Pd}{Pu} < \text{?} \\ \frac{Pd}{Pu} \geq \text{?}$$

$$\text{?} \text{indicates text missing or illegible when filed}$$

In the above formula (5), R is a gas constant, and is a flow rate coefficient. In the above formulas (6) and (7), κ is a specific heat ratio. As the flow rate coefficient ω, one of the above formulas (6) and (7) is selected according to a ratio Pd/Pu between the downstream gas pressure Pd and the upstream gas pressure Pu of the throttle valve 125.

Next, the control device 110 executes processing P4 for calculating the opening area A of the throttle valve 125. For example, the control device 110 calculates the geometric opening area A based on the opening degree θ of the throttle valve 125 by the opening area calculation unit F3 illustrated in FIG. 3. The opening area calculation unit F3 receives, as input, the opening degree θ of the throttle valve 125 acquired in the processing P1 for acquiring the sensor information described above, and calculates and outputs the geometric opening area A of the throttle valve 125. The geometric opening area A of the throttle valve 125 can be uniquely obtained according to the opening degree θ of the throttle valve 125.

In the control device 110 of the present embodiment, for example, a table created based on the relationship between the opening degree θ and the geometric opening area A of the throttle valve 125 is stored in the storage device 112 in advance. For example, the opening area calculation unit F3 receives the opening degree θ of the throttle valve 125 as an input, refers to the table stored in the storage device 112, and outputs the geometric opening area A of the throttle valve 125 corresponding to the input opening degree θ. By using such a table, a calculation load of the processing device 111 can be reduced.

The above table may define the relationship between the opening degree θ and the geometric opening area A in a region where the opening degree θ of the throttle valve 125 is a low opening degree of, for example, 15° or less at an angular interval narrower than that in a region where the opening degree θ is a high opening degree. This is because the lower the opening degree of the throttle valve 125, the larger the change in the geometric opening area A with respect to the opening degree θ. As a result, even when the opening degree θ of the throttle valve 125 is low, the geometric opening area A can be estimated with high accuracy.

Next, the control device 110 executes processing P5 for calculating an effective opening area EA of the throttle valve 125. For example, the control device 110 calculates the effective opening area EA of the throttle valve 125 by the effective opening area calculation unit F4 illustrated in FIG. 3. The effective opening area calculation unit F4 receives, for example, the opening degree θ of the throttle valve 125 acquired in the processing P1 for acquiring the sensor information described above, and the upstream gas pressure Pu and the downstream gas pressure Pd of the throttle valve 125, which are the outputs of the gas state calculation unit F1. The effective opening area calculation unit F4 receives the geometric opening area A of the throttle valve 125, which is the output of the opening area calculation unit F3.

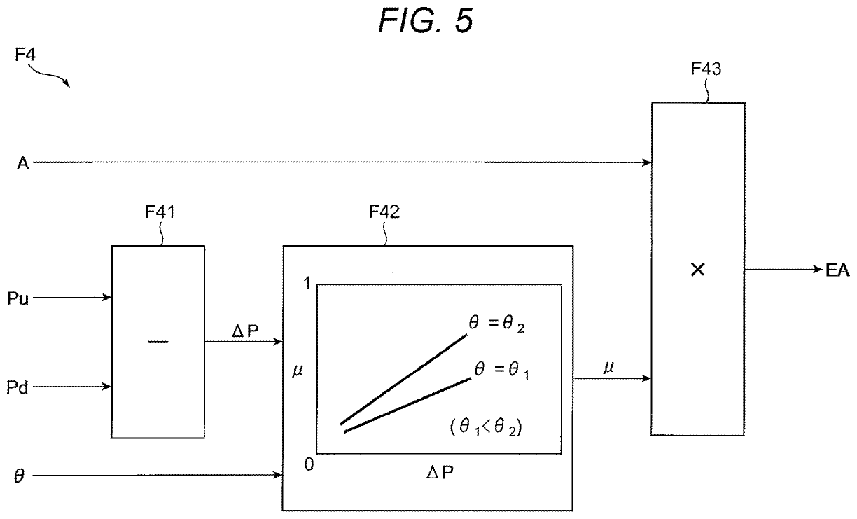

FIG. 5 is a more detailed functional block diagram of the effective opening area calculation unit F4 illustrated in FIG. 3. The effective opening area calculation unit F4 includes, for example, a differential pressure calculation unit F41, a correction coefficient calculation unit F42, and a correction unit F43. Similarly to the effective opening area calculation unit F4, each unit of the effective opening area calculation unit F4 represents the function of the control device 110 realized by executing the computer program stored in the storage device 112 by the processing device 111. That is, the differential pressure calculation unit F41, the correction coefficient calculation unit F42, and the correction unit F43 can be rephrased as a differential pressure calculation function, a correction coefficient calculation function, and a correction function, respectively.

For example, the differential pressure calculation unit F41 receives the upstream gas pressure Pu and the downstream gas pressure Pd of the throttle valve 125 as inputs, and calculates the difference between the upstream gas pressure Pu and the downstream gas pressure Pd, that is, the differential pressure ΔP before and after the throttle valve 125. The correction coefficient calculation unit F42 receives the differential pressure ΔP before and after the throttle valve 125, which is the output of the differential pressure calculation unit F41, and the opening degree θ of the throttle valve 125. The correction coefficient calculation unit F42 calculates a correction coefficient ρ for correcting the geometric opening area A of the throttle valve 125 to the effective opening area EA based on these inputs.

More specifically, the correction coefficient calculation unit F42 calculates the correction coefficient μ based on a function that defines a relationship between the differential pressure ΔP before and after the throttle valve 125 and the correction coefficient μ. Since it is generally unlikely that the effective opening area EA of the throttle valve 125 is larger than the geometric opening area A of the throttle valve 125, the correction coefficient μ is set in a range of 0 or more and 1.0 or less.

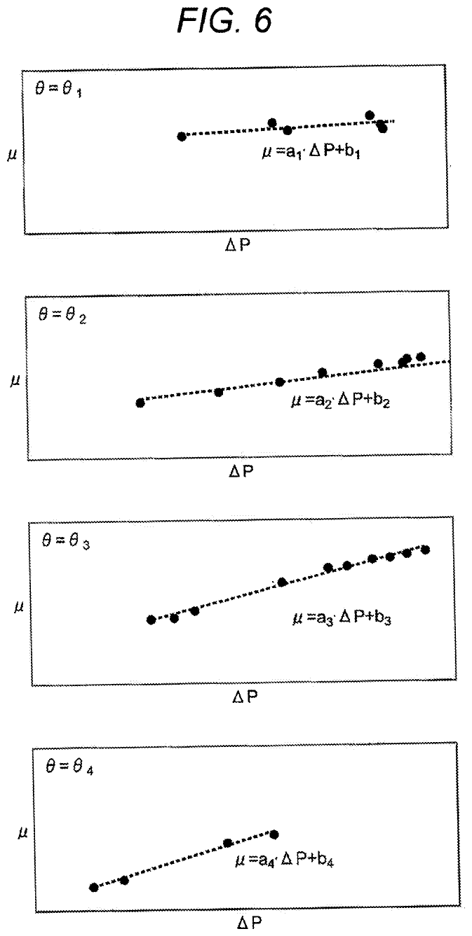

FIG. 6 is a graph illustrating an example of a function that defines the relationship between the differential pressure ΔP before and after the throttle valve 125 and the correction coefficient μ. In the example illustrated in FIG. 6, the correction coefficient μ and the differential pressure ΔP before and after the throttle valve 125 have, for example, a proportional relationship having a positive correlation, and have a relationship expressed by a function of the following formula (8).

μ=aᵢ·ΔP+bᵢ (8)

As illustrated in FIG. 6, for example, a plurality of functions defining the relationship between the differential pressure ΔP and the correction coefficient μ is defined according to the opening degree θ of the throttle valve 125. In the example illustrated in FIG. 6, the magnitude relationship from θ₁ to θ₄, which is the opening degree θ of the throttle valve 125, is θ₁<θ₂<θ₃<θ₄. In the example illustrated in FIG. 6, as the opening degree θ of the throttle valve 125 increases, a slope of the correction coefficient μ, that is, a ratio of the change in the correction coefficient μ to the differential pressure ΔP increases. That is, the ratio of change in the correction coefficient μ with respect to change in the differential pressure ΔP and the opening degree θ have a positive correlation.

The function that defines the relationship between the differential pressure ΔP of the throttle valve 125 and the correction coefficient μ may be defined at equal angular intervals from when the opening degree θ of the throttle valve 125 is fully closed to when it is fully opened, or may be defined at different angular intervals according to the operation region of the engine 130. More specifically, for example, in a region having a low opening degree in which the opening degree θ of the throttle valve 125 is 15° or less, the above function can be defined at an angular interval narrower than that in the other region. As a result, the storage device 112 of the control device 110 can be effectively used.

A plurality of functions defining the relationship between the differential pressure ΔP and the correction coefficient μ for each opening degree θ of the throttle valve 125 as illustrated in FIG. 6 is obtained in advance by, for example, an experiment using the engine system 100 and stored in the storage device 112. Note that the correction coefficient μ can be obtained using, for example, each numerical value obtained by an experiment of the engine system 100 and the following formula (9).

$$\begin{matrix}[ Equation 4 ] & \\ \frac{d m}{dt} = μ \cdot A \cdot Pu \cdot \sqrt{\frac{2}{R \cdot Tu}} \cdot ψ ( P u , Pd ) & ( 9 )\end{matrix}$$

In the above formula (9), dm/dt is the mass of the gas flowing into the throttle valve 125 per unit time. A is the geometric opening area of the throttle valve 125. Pu and Pd are the pressures of the gas on the upstream side and the downstream side of the throttle valve 125, respectively. Tu is the gas temperature on the upstream side of the throttle valve 125. R is the gas constant and ω is the flow rate coefficient. As the flow rate coefficient ω, one of the above formulas (6) and (7) is selected according to the ratio Pd/Pu between the downstream gas pressure Pd and the upstream gas pressure Pu of the throttle valve 125.

In the processing P5 of calculating the effective opening area EA of the throttle valve 125, the correction coefficient calculation unit F42 illustrated in FIG. 5 receives, for example, the opening degree θ of the throttle valve and the differential pressure GP before and after the throttle valve 125. The correction coefficient calculation unit F42 selects one function corresponding to the input opening degree e from the plurality of functions stored in the storage device 112, and calculates the correction coefficient μ based on the input differential pressure ΔP and the selected function.

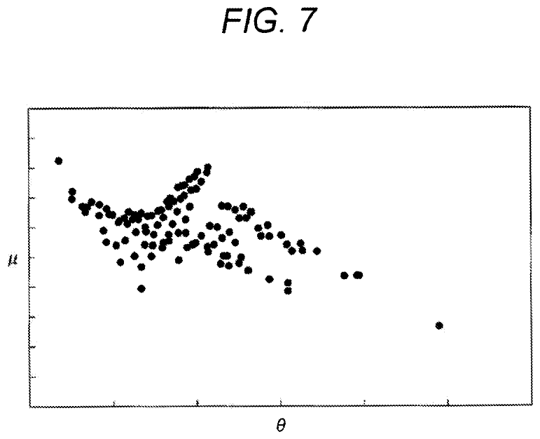

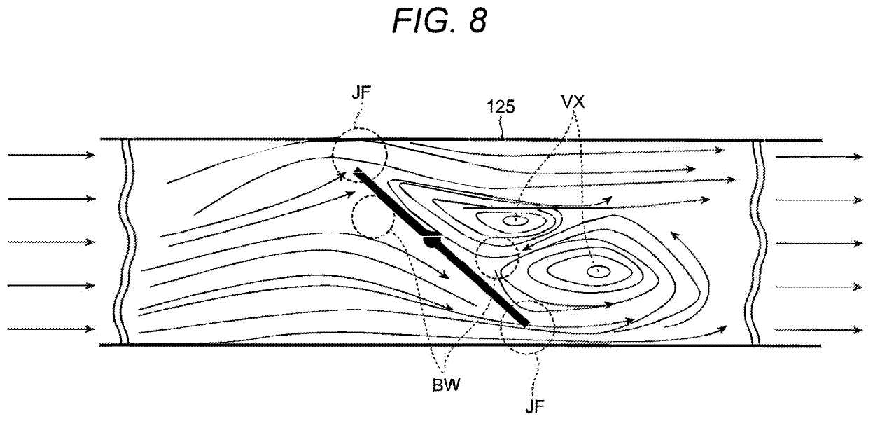

Here, the relationship between the opening degree θ of the throttle valve 125 and the correction coefficient ρ for correcting the geometric opening area A of the throttle valve 125 to the effective opening area EA will be described with reference to FIGS. 7 and 8.

FIG. 7 is a graph illustrating a relationship between the opening degree θ of the throttle valve 125 and the correction coefficient μ. The relationship illustrated in FIG. 7 is obtained, for example, by changing the rotation speed and the torque of the engine 130, measuring the opening degree of the throttle valve 125, the flow rate of the gas passing through the throttle valve 125, the pressure of the gas on the upstream side and the downstream side of the throttle valve 125, and the temperature of the gas on the downstream side in a steady state, and by the above formula (9). As illustrated in FIG. 7, the correction coefficient μ takes a value that varies with respect to the opening degree θ of the throttle valve 125, and cannot be uniquely determined with respect to the opening degree θ of the throttle valve 125.

FIG. 8 is a schematic diagram of a flow of gas passing through the throttle valve 125. The throttle valve 125 is, for example, a butterfly valve that is fully closed when the opening degree θ is 0° and fully open when the opening degree θ is 90°. When the opening degree θ of the throttle valve 125 is decreased, the flow velocity of the gas passing through the throttle valve 125 increases and the pressure decreases when the gas passes through the opening of the throttle valve 125 whose opening area is narrowed by the valve body. Then, after passing through the opening of the throttle valve 125, the pipeline rapidly expands and the pressure increases, so that a part of the gas flow is separated to generate a stagnation BW, a jet JF, and a vortex VX.

As a result, the opening area through which the gas actually flows, that is, the effective opening area EA, is reduced with respect to the geometric opening area A of the throttle valve 125. That is, the effective opening area EA changes according to the states of the upstream gas pressure Pu and the downstream gas pressure Pd before and after the throttle valve 125. Therefore, in the present embodiment, focusing on the point that the driving force of the fluid is caused by the pressure difference based on the Navier-Stokes equation, the correction coefficient μ illustrated in FIG. 7 is organized as a function that defines the relationship between the correction coefficient μ and the differential pressure ΔP before and after the throttle valve 125 according to the opening degree θ of the throttle valve 125 as illustrated in FIG. 6.

As illustrated in FIG. 6, when the opening degree θ of the throttle valve 125 is constant, the correction coefficient μ has a positive correlation with respect to the differential pressure ΔP and is directly proportional to the differential pressure ΔP. In addition, as the opening degree θ of the throttle valve 125 increases, a slope of a first order approximation of the correction coefficient μ increases. This is considered to be because, under the condition that the opening degree θ of the throttle valve 125 is constant, the flow rate, that is, the flow velocity of the gas changes, the Reynolds number changes, separation of the flow of the gas, the stagnation BW, the jet JF, the vortex VX, and the like are generated in the vicinity of the valve body of the throttle valve 125, and the correction coefficient μ changes. In addition, since there is a correlation that the differential pressure ΔP before and after the throttle valve 125 increases as the flow velocity of the gas flowing in the vicinity of the valve body of the throttle valve 125 increases in terms of fluid dynamics, it is considered that such a result has been obtained.

In the present embodiment, the correction coefficient is arranged with the differential pressure ΔP before and after the throttle valve 125 as an axis, but the correction coefficient μ may be arranged with the pressure ratio Pd/Pu upstream and downstream of the throttle valve 125 as an axis. In this case, when the opening degree θ of the throttle valve 125 is constant, the correction coefficient μ is directly proportional to the pressure ratio Pd/Pu with a negative correlation, and when the opening degree θ of the throttle valve 125 increases, the slope of the first order approximation of the correction coefficient μ decreases. As described above, the correction coefficient calculation unit F42 illustrated in FIG. 5 can estimate the correction coefficient μ using the differential pressure ΔP between the upstream gas pressure Pu and the downstream gas pressure Pd of the throttle valve 125, and the opening degree θ of the throttle valve 125.

Furthermore, the correction unit F43 illustrated in FIG. 5 calculates the effective opening area EA of the throttle valve 125 using the geometric opening area A of the throttle valve 125, which is the output of the opening area calculation unit F3, and the correction coefficient μ, which is the output of the correction coefficient calculation unit F42, as inputs. For example, the correction unit F43 calculates the effective opening area EA of the throttle valve 125 by multiplying the geometric opening area A of the throttle valve 125 by the correction coefficient μ (EA=ρ×A). Thus, the processing P5 for calculating the effective opening area EA of the throttle valve 125 illustrated in FIG. 4 ends.

Next, the control device 110 executes processing P6 of calculating the flow rate of the gas passing through the throttle valve 125. For example, the control device 110 calculates the gas flow rate GF passing through the throttle valve 125 using the mass flux MF, which is the output of the mass flux calculation unit F2, and the effective opening area EA, which is the output of the effective opening area calculation unit F4, as inputs by the passing gas flow rate calculation unit F5 illustrated in FIG. 3.

Specifically, the passing gas flow rate calculation unit F5 calculates the gas flow rate GF passing through the throttle valve 125 by multiplying the mass flux MF of the gas passing through the throttle valve 125 by the effective opening area EA of the throttle valve 125 (GF=MF×EA). Thus, the processing P6 illustrated in FIG. 4 ends. The control device 110 estimates an in-cylinder inflow gas amount, which is the amount of gas flowing into the combustion chamber 131 of the engine 130, based on the gas flow rate GF passing through the throttle valve 125 calculated from the processing P1 to the processing P6.

Hereinafter, the operation of the internal combustion engine control device 110 according to the present embodiment will be described.

From the viewpoint of reducing an environmental load, regulations on exhaust gas from automobiles tend to be stricter in recent years. In order to cope with such strict regulations, it is necessary to increase the accuracy of an air-fuel ratio control of the engine 130 constituting the engine system 100. In order to increase the accuracy of the air-fuel ratio control of the engine 130, it is required to estimate the amount of air flowing into the combustion chamber 131 of the engine 130, that is, the amount of in-cylinder inflow gas with high accuracy even in a transient state of the engine such as at the time of sudden acceleration or sudden deceleration of the automobile. This is because the fuel injection amount that realizes the target air-fuel ratio with high accuracy can be set by estimating the in-cylinder inflow gas amount with high accuracy.

As described above, the internal combustion engine control device 110 of the present embodiment includes the mass flux calculation unit F2, the opening area calculation unit F3, the effective opening area calculation unit F4, and the passing gas flow rate calculation unit F5. The mass flux calculation unit F2 calculates the mass flux MF of the gas passing through the throttle valve 125 based on the upstream gas temperature Tu, the upstream gas pressure Pu, and the downstream gas pressure Pd of the throttle valve 125. The opening area calculation unit F3 calculates the opening area A of the throttle valve 125 based on the opening degree θ of the throttle valve 125. The effective opening area calculation unit F4 calculates the effective opening area EA of the throttle valve 125 based on the upstream gas pressure Pu, the downstream gas pressure Pd, the opening degree θ, and the opening area A. The passing gas flow rate calculation unit F5 calculates the gas flow rate GF passing through the throttle valve 125 based on the mass flux MF and the effective opening area EA.

With such a configuration, the internal combustion engine control device 110 of the present embodiment can estimate the gas flow rate GF passing through the throttle valve 125 with high accuracy, and can estimate the in-cylinder inflow gas amount of the engine 130 with higher accuracy than before. More specifically, the effective opening area EA of the throttle valve 125 can be estimated with high accuracy based on the upstream gas pressure Pu, the downstream gas pressure Pd, the opening degree θ, and the geometric opening area A of the throttle valve 125 even in a transient state of the engine 130, for example, at the time of sudden acceleration or sudden deceleration of an automobile. As a result, the gas flow rate GF passing through the throttle valve 125 can be estimated with high accuracy based on the mass flux MF and the effective opening area EA, and the in-cylinder inflow gas amount can be estimated with high accuracy. Therefore, in the engine 130, it is possible to set the fuel injection amount that realizes the target air-fuel ratio with high accuracy, and it is possible to cope with strict regulation of the exhaust gas.

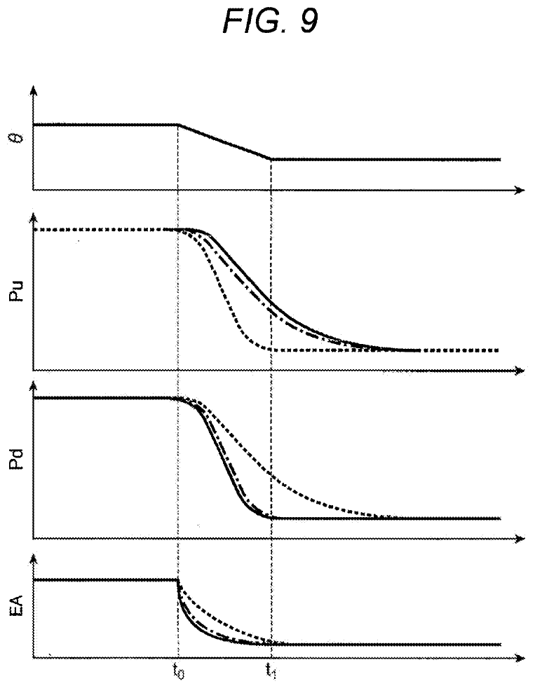

FIG. 9 is a graph illustrating time changes of the opening degree θ of the throttle valve 125, the upstream gas pressure Pu, the downstream gas pressure Pd, and the effective opening area EA at the time of deceleration. In the graphs of the upstream gas pressure Pu, the downstream gas pressure Pd, and the effective opening area EA, solid lines indicate actual values of the upstream gas pressure Pu, the downstream gas pressure Pd, and the effective opening area EA. In addition, a broken line indicates an estimation value of each value by a conventional internal combustion engine control device, and a one-dot chain line indicates an estimation value of each value by the internal combustion engine control device 110 according to the present embodiment.

At a time t0, the throttle valve 125 starts to close and the opening degree θ decreases. A conventional internal combustion engine control device calculates the effective opening area EA of the throttle valve 125 based on the opening degree θ of the throttle valve 125. Therefore, in the conventional internal combustion engine control device, the estimation value of the effective opening area EA indicated by the broken line depends only on the opening degree θ of the throttle valve 125, and the error from the actual effective opening area EA indicated by the solid line increases when the differential pressure between the upstream gas pressure Pu and the downstream gas pressure Pd of the throttle valve 125 is large. In the conventional internal combustion engine control device, the estimation value of the downstream gas pressure Pd of the throttle valve 125 indicated by the broken line is also an excessively estimation value with respect to the actual downstream gas pressure Pd indicated by the solid line.

Meanwhile, as described above, the internal combustion engine control device 110 of the present embodiment calculates the effective opening area EA based on the opening degree θ of the throttle valve 125, the upstream, gas pressure Pu, and the downstream gas pressure Pd. Therefore, in the internal combustion engine control device 110 of the present embodiment, the estimation value of the effective opening area EA indicated by the one-dot chain line matches well with the actual effective opening area EA indicated by the solid line.

In addition, in the internal combustion engine control device 110 of the present embodiment, the estimation value of the downstream gas pressure Pd indicated by the one-dot chain line is also well matched with the actual downstream gas pressure Pd indicated by the solid line. As a result, the gas flow rate GF passing through the throttle valve 125 can be estimated with high accuracy, and the in-cylinder inflow gas amount of the engine 130 can be estimated with high accuracy. As a result, the exhaust air-fuel ratio rich can be improved. In addition, according to the internal combustion engine control device 110 of the present embodiment, it is possible to prevent the underestimation of the downstream gas pressure Pd of the throttle valve 125 at the time of acceleration and improve the exhaust air-fuel ratio lean.

As described above, according to the present embodiment, by including the effective opening area calculation unit F4 that performs multiplication correction of the geometric opening area A based on the upstream gas pressure Pu and the downstream gas pressure Pd of the throttle valve 125, the effective opening area EA can be accurately estimated even in the transient state of the engine 130, and the gas flow rate GF passing through the throttle valve 125 can be estimated with high accuracy. Therefore, according to the present embodiment, it is possible to provide the internal combustion engine control device 110 capable of estimating the in-cylinder inflow gas amount with high accuracy, controlling the appropriate fuel injection amount according to the in-cylinder inflow gas amount, and improving the fuel consumption and the exhaust emission.

In the internal combustion engine control device 110 according to the present embodiment, the effective opening area calculation unit F4 includes the differential pressure calculation unit F41, the correction coefficient calculation unit F42, and the correction unit F43. The differential pressure calculation unit F41 calculates the differential pressure ΔP between the upstream gas pressure Pu and the downstream gas pressure Pd. The correction coefficient calculation unit F42 calculates a correction coefficient μ for correcting the opening area A to the effective opening area EA based on the differential pressure ΔP and the opening degree θ. The correction unit F43 obtains the effective opening area EA by multiplying the opening area A by the correction coefficient μ.

With this configuration, the effective opening area calculation unit F4 can estimate the correction coefficient μ for correcting the geometric opening area A of the throttle valve 125 to the effective opening area EA based on the upstream gas pressure Pu, the downstream gas pressure Pd, and the opening degree e of the throttle valve 125. Furthermore, the effective opening area calculation unit F4 can calculate the effective opening area EA by multiplying the geometric opening area A of the throttle valve 125 by the correction coefficient μ. As a result, the effective opening area calculation unit F4 can appropriately calculate the correction coefficient μ and the effective opening area EA even under the condition that the pressure state before and after the throttle valve 125 changes in the transient state of the engine 130. Therefore, the passing gas flow rate calculation unit F5 can calculate the gas flow rate GF passing through the throttle valve 125 with high accuracy even in the transient state of the engine 130. As a result, the downstream gas pressure Pd of the throttle valve 125 can be calculated more accurately, and the in-cylinder inflow gas amount can be estimated with high accuracy.

In addition, in the internal combustion engine control device 110 of the present embodiment, the correction coefficient calculation unit F42 calculates the correction coefficient μ based on the relationship between the differential pressure ΔP set according to the opening degree θ of the throttle valve 125 and the correction coefficient μ. As a result, even when the opening degree θ of the throttle valve 125 changes depending on the operating condition of the engine 130, the effective opening area EA can be estimated with high accuracy. More specifically, as described above, by functionalizing the relationship between the correction coefficient μ and the differential pressure ΔP for each opening degree θ of the throttle valve 125, the correction coefficient μ can be accurately estimated even when the opening degree θ suddenly changes and the pressure before and after the throttle valve 125 changes.

In addition, in the internal combustion engine control device 110 of the present embodiment, the relationship between the differential pressure ΔP before and after the throttle valve 125 and the correction coefficient μ is a proportional relationship having a positive correlation. In other words, the correction coefficient μ increases as the differential pressure ΔP before and after the throttle valve 125 increases. As a result, even when the differential pressure ΔP changes under a condition where the opening degree θ of the throttle valve 125 is constant depending on the operating condition of the engine 130, the effective opening area EA can be estimated with high accuracy.

In addition, in the internal combustion engine control device 110 of the present embodiment, the ratio of the change in the correction coefficient μ to the change in the differential pressure ΔP before and after the throttle valve 125 and the opening degree θ have a positive correlation. That is, as the opening degree θ of the throttle valve 125 increases, the slope of the correction coefficient μ that is a function of the differential pressure ΔP increases. As a result, the correction coefficient μ can be increased as the opening degree θ of the throttle valve 125 increases, and the effective opening area EA of the throttle valve 125 can be estimated with high accuracy even when the opening degree θ of the throttle valve 125 changes depending on the operating condition of the engine 130.

Note that the internal combustion engine control device 110 of the present embodiment uses the upstream gas temperature Tu, the upstream gas pressure Pu, and the downstream gas pressure Pd, which are estimation values by the gas state calculation unit F1, as the upstream gas temperature, the upstream gas pressure, and the downstream gas pressure of the throttle valve 125. However, the control device 110 may use, for example, the upstream gas temperature, the upstream gas pressure, and the downstream gas pressure of the throttle valve 125 detected by the intake air temperature sensor 123a, the atmospheric pressure sensor 137, and the intake pipe pressure sensor 126. As a result, even when the gas state calculation unit F1 is not provided, the upstream gas temperature, the upstream gas pressure, and the downstream gas pressure of the throttle valve 125 can be obtained.

In addition, the downstream gas pressure of the throttle valve 125 is correlated between the rotation speed N_eng of the engine 130 and the opening degree θ of the throttle valve 125 or the load (torque) of the engine 130. Therefore, the downstream gas pressure of the throttle valve 125 may be given by, for example, a map with the rotation speed N_eng of the engine 130 and the opening degree θ of the throttle valve 125, or the rotation speed N_eng of the engine 130 and the load of the engine 130 as axes. As a result, even when the atmospheric pressure sensor 137, the intake pipe pressure sensor 126, and the gas state calculation unit F1 are not provided, the downstream gas pressure of the throttle valve 125 can be calculated.

In addition, as illustrated in FIG. 6, the internal combustion engine control device 110 of the present embodiment uses a method of functionalizing the relationship between the differential pressure ΔP before and after the throttle valve 125 and the correction coefficient μ. However, a map that defines the relationship between the differential pressure ΔP and the opening degree θ of the throttle valve 125 may be set. As a result, the correction coefficient μ can be accurately calculated by simple processing. For example, the control device 110 may calculate the correction coefficient μ using the pressure ratio Pd/Pu between the upstream gas pressure Pu and the downstream gas pressure Pd of the throttle valve 125 and the opening degree θ of the throttle valve 125. By approximating the correction coefficient μ by the differential pressure ΔP or the pressure ratio Pd/Pu before and after the throttle valve 125 and using a parameter with higher approximation accuracy, the correction coefficient μ can be estimated with higher accuracy.

### Second Embodiment

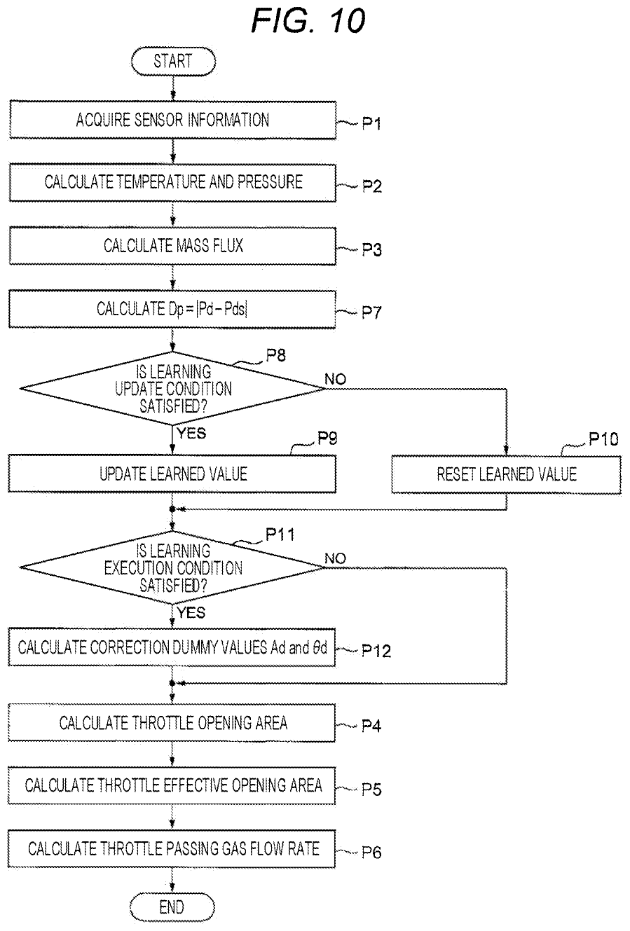

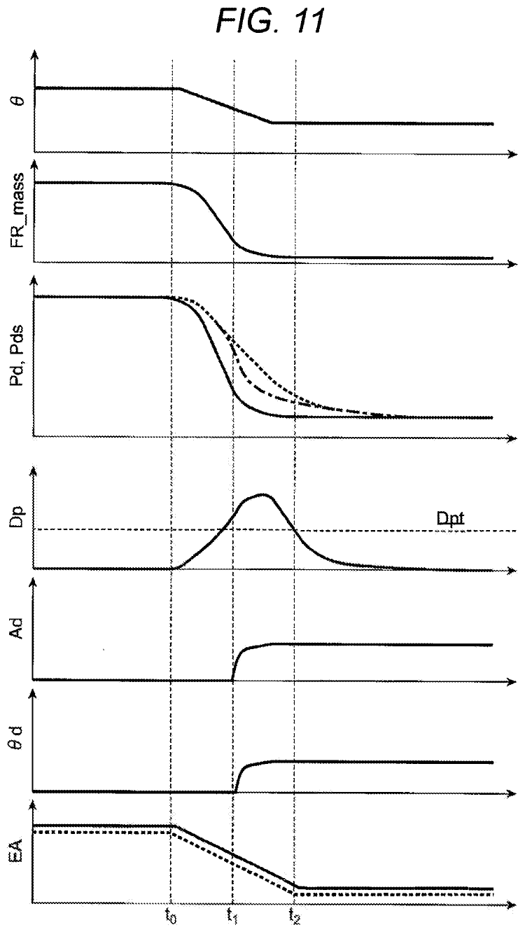

Next, a second embodiment of the internal combustion engine control device of the present disclosure will be described with reference to FIGS. 1 to 3 and FIGS. 5 to S and FIGS. 10 and 11. FIG. 10 is a flowchart illustrating an example of a flow of processing of calculating the gas flow rate GF passing through the throttle valve 125 by the internal combustion engine control device according to the present embodiment.

The internal combustion engine control device of the present embodiment is different from the control device 110 of the first embodiment described above in that machine learning is performed in consideration of the influence of dirt and the like adhering to the periphery of the valve body of the throttle valve 125. Since other configurations of the control device of the present embodiment are similar to those of the control device 110 of the first embodiment, the same components are denoted by the same reference numerals, and the description thereof will be omitted.

The processing from the processing P1 to the processing P3 by the control device of the present embodiment illustrated in FIG. 10 is similar to the processing from the processing P1 to the processing P3 by the control device 110 of the first embodiment illustrated in FIG. 4.

After the processing P3 of calculating the mass flux MF of the gas passing through the throttle valve 125 ends, the control device of the present embodiment executes following processing P7 to P12.

In processing P7, the control device sets, for example, the detection value Pds of the downstream gas pressure of the throttle valve 125 detected by the intake pipe pressure sensor 126 illustrated in FIG. 1 and the downstream gas pressure Pd which is the output of the gas state calculation unit F1 as inputs of the effective opening area calculation unit F4. In the processing P7, for example, the effective opening area calculation unit F4 calculates the absolute value Dp=|Pd−Pds| of the difference between the detection value Pds of the downstream gas pressure of the throttle valve 125 and the downstream gas pressure Pd which is the estimation value.

Next, in processing P8, for example, the effective opening area calculation unit F4 determines whether a plurality of learning update conditions as follows are satisfied. Condition 1: The correction dummy value Ad of the geometric opening area A of the throttle valve 125 and the correction dummy value θd of the opening degree θ are learned within a predetermined period. Condition 2: The absolute value Dp(n) of the difference between the detection value Pds of the downstream gas pressure of the throttle valve 125 calculated in the current processing and the downstream gas pressure Pd which is the estimation value thereof is smaller than the absolute value Dp(n−1) of the difference calculated in the previous processing (Dp(n)<Dp(n−1)). Condition 3: A steady operation state in which a change in the mass flow rate FR_mass is smaller than a predetermined threshold.

By setting the above condition 2, it is possible to determine whether or not the difference between the detection value Pds of the downstream gas pressure of the throttle valve 125 and the downstream gas pressure Pd, which is an estimation value thereof, has decreased by learning. Therefore, only when there is an effect of learning, a learned value can be updated, and failure of learning can be prevented. In addition, by setting the above condition 3, the learned value can be updated under a more stable operating condition, and the accuracy of learning can be improved.

In the processing P8, for example, the effective opening area calculation unit F4 determines a plurality of learning update conditions as described above, executes processing P9 of updating the learned value when determining that the learning update conditions are satisfied (YES), and executes processing P10 of resetting the learned value when determining that the learning update conditions are not satisfied (NO).

In the processing P9, for example, the effective opening area calculation unit F4 causes the storage device 112 to store the correction dummy value Ad of the geometric opening area A of the throttle valve 125 and the correction dummy value θd of the opening degree θ as the correction value Av of the opening area A and the correction value θv of the opening degree θ, respectively.

Meanwhile, in the processing P10, for example, the effective opening area calculation unit F4 resets the correction dummy value Ad of the geometric opening area A of the throttle valve 125 and the correction dummy value θd of the opening degree θ to 0.

Next, in processing P11, for example, the effective opening area calculation unit F4 determines whether a plurality of learning execution conditions as follows are satisfied. Condition 1: The absolute value Dp of the difference between the detection value Pds of the downstream gas pressure of the throttle valve 125 and the downstream, gas pressure Pd that is the estimation value thereof is equal to or more than a threshold. Condition 2: A transient operation state in which a change in the mass flow rate FR_mass is equal to or more than a predetermined threshold.

Here, there is a correlation between the downstream gas pressure of the throttle valve 125 and the in-cylinder inflow gas amount which is the amount of gas flowing into the combustion chamber 131 of the engine 130. Therefore, when there is a deviation between the downstream gas pressure Pd, which is an estimation value of the downstream gas pressure of the throttle valve 125, and the detection value Pds of the downstream gas pressure, which is a detection value of the intake pipe pressure sensor 126, it is considered that an error occurs in the estimation of the gas flow rate GF passing through the throttle valve 125.

Therefore, the above condition 1 is set as the learning execution condition in the above processing P11.

The condition 1 of the learning execution condition may be, for example, a difference between the detection value of the air-fuel ratio of the exhaust gas by the air-fuel ratio sensor 143 and a target air-fuel ratio as a threshold. Further, by setting the condition 2 as the learning execution condition in the processing P11, the learning is appropriately executed under the condition that the estimation error of the in-cylinder inflow gas amount is larger than the predetermined value, and the learning accuracy is improved. As the condition 2 of the learning execution condition, the transient operation state may be determined using a change rate of the opening degree θ of the throttle valve 125.

In the processing P11, for example, the effective opening area calculation unit F4 executes processing P12 of executing learning when determining that the plurality of learning execution conditions as described above are satisfied (YES).

In addition, for example, when the effective opening area calculation unit F4 determines that the plurality of learning execution conditions as described above are not satisfied (NO), the effective opening area calculation unit F4 executes the processing P4 of calculating the geometric opening area A of the throttle valve 125 by the opening area calculation unit F3 as in the first embodiment.

In processing P12, for example, the effective opening area calculation unit F4 calculates the correction dummy value Ad of the geometric opening area A of the throttle valve 125 and the correction dummy value θd of the opening degree θ of the throttle valve 125. Here, the absolute value Dp of the difference between the detection value Pds of the downstream gas pressure of the throttle valve 125 and the downstream gas pressure Pd which is the estimation value thereof, and the opening area A corresponding to the opening degree θ of the throttle valve 125 at that time and the correction dummy values Ad and θd of the opening degree θ are calculated.

More specifically, as illustrated in the following Table 1, the absolute value Dp of the difference between the detection value Pds of the downstream gas pressure of the throttle valve 125 and the downstream gas pressure Pd that is an estimation value thereof is divided into a plurality of regions. Then, the correction dummy values Ad and θd are set for each area of the absolute value Dp of the difference. In Table 1 below, the correction dummy values Ad and θd are set to be larger as the absolute value Dp of the difference is larger. That is, in the following Table 1, Dp1<Dp2<Dp3, A1<A2<A3, and θ₁<θ₂<θ₃ are satisfied.

TABLE 1

| Absolute value Dp of difference | Dp 1 | Dp 2 | Dp 3 |
|---|---|---|---|
| Correction dummy value Ad of | A1 | A2 | A3 |
| opening area A | | | |
| Correction dummy value θd of | θ₁ | θ₂ | θ₃ |
| opening degree θ | | | |

As a result, the correction amount increases at an initial stage of learning in which the absolute value Dp of the difference between the detection value Pds of the downstream gas pressure of the throttle valve 125 and the downstream gas pressure Pd which is the estimation value thereof is large, and the correction amount decreases as the learning progresses and the absolute value Dp of the difference decreases. This makes it possible to prevent learning from failing.

Next, in the processing P4, as in the above-described first embodiment, the control device calculates the geometric opening area based on the opening degree θ of the throttle valve 125 by, for example, the opening area calculation unit F3 illustrated in FIG. 3. Furthermore, in the control device of the present embodiment, in the processing P4, for example, the effective opening area calculation unit F4 subtracts the correction value Av from the opening area A calculated by the opening area calculation unit F3 to calculate the corrected opening area Ac=A−Av.

Here, the correction value Av of the opening area A is a positive value, and the corrected opening area Ac is smaller than the geometric opening area A of the throttle valve 125. As described above, by making the corrected opening area Ac smaller than the geometric opening area A, for example, even when the actual opening area with respect to the opening degree θ of the throttle valve 125 decreases due to contamination of the valve body of the throttle valve 125 or the like, the opening area of the throttle valve 125 can be appropriately calculated.

In addition, the control device of the present embodiment calculates the corrected opening degree θc of the throttle valve 125 in the processing P5 of calculating the effective opening area of the throttle valve 125. More specifically, for example, the control device calculates the corrected opening degree θc=θ−θv by subtracting the correction value θv from the opening degree θ of the throttle valve 125 by the effective opening area calculation unit F4. Here, the correction value θv of the opening degree θ is a positive value, and the corrected opening degree θc is smaller than the actual opening degree θ of the throttle valve 125.

Thereafter, the effective opening area calculation unit F4 calculates the correction coefficient μ similarly to the described first embodiment by using the corrected opening degree θc instead of the actual opening degree θ of the throttle valve 125. As a result, the correction coefficient μ can be calculated more accurately based on the graph illustrated in FIG. 6.

Furthermore, using the corrected opening area Ac, the effective opening area calculation unit F4 calculates the effective opening area EA by multiplying the corrected opening area Ac by the correction coefficient μ as in the first embodiment.

As a result, for example, even when the actual opening area of the throttle valve 125 decreases due to dirt or the like around the valve body of the throttle valve 125, the effective opening area EA in consideration of the influence of the correction coefficient μ can be calculated. Therefore, in the next processing P6, the gas flow rate GF passing through the throttle valve 125 can be calculated more accurately.

Hereinafter, the operation of the internal combustion engine control device according to the present embodiment will be described. FIG. 11 is a graph illustrating time changes of the opening degree θ of the throttle valve 125, the mass flow rate FR_mass of the gas, the downstream gas pressure Pd and the detection value Pds thereof, the absolute value Dp of the difference between the downstream gas pressure Pd and the detection value Pds thereof, the correction dummy value Ad of the opening area A, the correction dummy value Od of the opening degree e, and the effective opening area EA at the time of deceleration.

In the graph of the downstream gas pressure Pd and the detection value Pds thereof, a solid line indicates the detection value Pds of the downstream gas pressure, a broken line indicates the downstream gas pressure Pd before the learned value is updated, and a one-dot chain line indicates the downstream gas pressure Pd after the learned value is updated. In the graph of the effective opening area EA, a solid line indicates the effective opening area EA before the learned value is updated, and a broken line indicates the effective opening area EA after the learned value is updated.

At the time t0, the throttle valve 125 starts to close, the opening degree θ decreases, and the detection value Pds of the downstream gas pressure of the throttle valve 125 starts to decrease. Then, the difference Dp between the downstream gas pressure Pd before the update of the learned value indicated by the broken line and the detection value Pds of the downstream gas pressure of the throttle valve 125 increases and becomes equal to or more than the threshold Dpt at a time t1, and the learning execution condition in the processing P11 described above is satisfied.

As a result, in the processing P12 described above, the correction dummy value Ad of the geometric opening area A of the throttle valve 125 and the correction dummy value θd of the opening degree θ of the throttle valve 125 are calculated. As a result, the learning is advanced, the learned value is updated, and the effective opening area EA is corrected to decrease as indicated by a broken line in the graph of the effective opening area EA.

As described above, the internal combustion engine control device according to the present embodiment learns at least one of the correction value Av of the opening area A and the correction value θv of the opening degree θ based on the downstream gas pressure Pd that is the estimation value of the downstream gas pressure of the throttle valve 125 and the detection value Pds of the downstream gas pressure by the intake pipe pressure sensor 126.

With such a configuration, the internal combustion engine control device of the present embodiment can calculate the accurate effective opening area EA and calculate the gas flow rate GF passing through the throttle valve 125 even when the actual opening area A decreases due to dirt adhering to the periphery of the valve body of the throttle valve 125. As a result, the in-cylinder inflow gas amount of the engine 130 can be estimated with high accuracy, and deterioration of fuel consumption and exhaust emission can be prevented.

In addition, the internal combustion engine control device according to the present embodiment learns at least one of the correction value Av of the opening area A and the correction value θv of the opening degree θ when the difference Dp between the downstream gas pressure Pd as the estimation value and the detection value Pds of the downstream gas pressure is equal to or more than the threshold. With such a configuration, the internal combustion engine control device of the present embodiment can prevent the difference Dp between the downstream gas pressure Pd, which is the estimation value, and the detection value Pds of the downstream gas pressure from exceeding the threshold.

In addition, the internal combustion engine control device of the present embodiment calculates the effective opening area EA using at least one of the opening area Ac after the correction obtained by subtracting the correction value Av of the opening area A from the opening area A and the opening degree θc after the correction obtained by subtracting the correction value θv of the opening degree θ from the opening degree θ. With such a configuration, the internal combustion engine control device of the present embodiment can more accurately calculate the effective opening area EA even when, for example, the actual opening area A or the opening degree θ of the throttle valve 125 decreases.

Although the embodiments of the internal combustion engine control device according to the present disclosure have been described in detail with reference to the drawings, the specific configuration is not limited to the embodiments, and design changes and the like without departing from the gist of the present disclosure are included in the present disclosure.

### REFERENCE SIGNS LIST

110 internal combustion engine control device
125 throttle valve
A opening area
Ac opening area after correction
Av correction value of opening area
Dpt threshold
EA effective opening area
F2 mass flux calculation unit
F3 opening area calculation unit
F4 effective opening area calculation unit
F41 differential pressure calculation unit
F42 correction coefficient calculation unit
F43 correction unit
F5 passing gas flow rate calculation unit
GF gas flow rate
MF mass flux
Pd downstream gas pressure (estimation value)
Pds detection value of downstream gas pressure
Pu upstream gas pressure
Tu upstream gas temperature
ΔP differential pressure
μ correction coefficient
θ opening degree
θc opening degree after correction
θv correction value of opening degree

1. An internal combustion engine control device comprising:
a mass flux calculation unit that calculates a mass flux of gas passing through a throttle valve based on an upstream gas temperature, an upstream gas pressure, and a downstream gas pressure of the throttle valve;
an opening area calculation unit that calculates an opening area of the throttle valve based on an opening degree of the throttle valve;
an effective opening area calculation unit that calculates an effective opening area of the throttle valve based on the upstream gas pressure, the downstream gas pressure, the opening degree, and the opening area; and
a passing gas flow rate calculation unit that calculates a gas flow rate passing through the throttle valve based on the mass flux and the effective opening area.

2. The internal combustion engine control device according to claim 1, wherein the effective opening area calculation unit includes
a differential pressure calculation unit that calculates a differential pressure between the upstream gas pressure and the downstream gas pressure,
a correction coefficient calculation unit that calculates a correction coefficient for correcting the opening area to the effective opening area based on the differential pressure and the opening degree, and
a correction unit that obtains the effective opening area by multiplying the opening area by the correction coefficient.

3. The internal combustion engine control device according to claim 2, wherein the correction coefficient calculation unit calculates the correction coefficient based on a relationship between the differential pressure set according to the opening degree and the correction coefficient.

4. The internal combustion engine control device according to claim 3, wherein the relationship between the differential pressure and the correction coefficient is a proportional relationship having a positive correlation.

5. The internal combustion engine control device according to claim 4, wherein a ratio of a change in the correction coefficient to a change in the differential pressure and the opening degree have a positive correlation.

6. The internal combustion engine control device according to claim 1, wherein at least one of a correction value of the opening area and a correction value of the opening degree is learned based on an estimation value and a detection value of the downstream gas pressure.

7. The internal combustion engine control device according to claim 6, wherein the learning is performed in a case where a difference between the estimation value and the detection value is equal to or more than a threshold.

8. The internal combustion engine control device according to claim 6, wherein the effective opening area is calculated by using at least one of the opening area after correction obtained by subtracting the correction value of the opening area from the opening area and the opening degree after correction obtained by subtracting the correction value of the opening degree from the opening degree.
